(19) United States
(12) Patent Application Publication
(10) Pub. No.: US 2009/0268707 A1
(43) Pub. Date: Oct. 29, 2009

(54) METHOD TO IMPLEMENT TRANSMISSION TIME INTERVAL BUNDLING

(75) Inventors: Diana Pani, Montreal (CA); Christopher R. Cave, Montreal (CA); Paul Marinier, Brossard (CA); Benoit Pelletier, Roxboro (CA); Vincent Roy, Longueuil (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/429,047

(22) Filed: Apr. 23, 2009

Related U.S. Application Data
(60) Provisional application No. 61/047,808, filed on Apr. 25, 2008.
(60) Provisional application No. 61/156,288, filed on Feb. 27, 2009.

(51) Int. Cl. H04J 3/00

(52) U.S. Cl. 370/345

(57) ABSTRACT

Methods for implementing transmission time interval (TTI) bundling, and a wireless transit/receive unit (WTRU) and a base station configured to process the methods are shown. The method includes the WTRU receiving a TTI control signal and/or configuration message from a network and the WTRU transmitting TTI control signals to the network. The control signals and/or configuration message may be sent via Layer 1, Layer 2, or Layer 3 messages. Signaling may be implemented, for example, using or via an enhanced-absolute grant channel (E-AGCH), a high speed-shared control channel (HS-SCCH), Medium Access Control (MAC) headers, radio resource control messages, a logical channel ID, information elements, and the control signals and/or configuration may include, for example, information related to triggering criteria, activation and de-activation, number of retransmissions, handover related information and configuration information.

### CROSS REFERENCE TO RELATED APPLICATIONS

This application claims the benefit of U.S. provisional application Nos. 61/047,808, filed Apr. 25, 2008 and 61/156,288, filed Feb. 27, 2009, which are incorporated by reference as if fully set forth.

### FIELD OF INVENTION

This application is related to wireless communications.

### BACKGROUND

Several techniques have been proposed to enhance the uplink coverage of a high speed packet access (HSPA) wireless communication system. One feature of HSPA is the use of a 2 ms transmission time interval (TTI). For a given transport block size (TBS), the use of 2 ms TTIs results in smaller amounts of energy per information bit, thus reducing coverage. The use of TTI bundling, also referred to as autonomous retransmission, has been identified as one way to enhance the uplink coverage. This technique allows a wireless transmit receive unit (WTRU) to make a predetermined number of retransmissions without waiting for a non-acknowledge signal (NACK) between the transmissions.

The use of TTI bundling may be controlled through the high speed shared control channel (HS-SCCH). However, there are limitations to a base station's control of TTI bundling via the HS-SCCH such as, but not limited to, guaranteeing the delivery of control information via the HS-SCCH or handling soft handover on the condition that TTI bundling maybe activated.

The use of TTI bundling in high speed uplink packet access (HSUPA) also has a number of deficiencies with respect to this method such as, but not limited to, not knowing which entity controls activation/deactivation of TTI bundling mode and when, not defining criteria for using TTI bundling and not communicating to the other entity(ies) that TTI bundling is active/inactive.

### SUMMARY

Methods for implementing transmission time interval (TTI) bundling, and a wireless transit/receive unit (WTRU) and a base station configured to process the methods are shown. The method includes the WTRU receiving a TTI control signal and/or configuration message from a network and the WTRU transmitting TTI control signals to the network. The control signals and/or configuration message may be sent via Layer 1, Layer 2, or Layer 3 messages. Signaling may be implemented, for example, using or via an enhanced-absolute grant channel (E-AGCH), a high speed-shared control channel (HS-SCCH), Medium Access Control (MAC) headers, radio resource control messages, a logical channel ID, information elements, and the control signals and/or configuration may include, for example, information related to triggering criteria, activation and de-activation, number of retransmissions, handover related information and configuration information.

### BRIEF DESCRIPTION OF THE DRAWINGS

A more detailed understanding may be had from the following description, given by way of example in conjunction with the accompanying drawings wherein:

FIG. 1 shows an example wireless communications system including functional block diagrams of a wireless transmit/receive unit (WTRU) and a base station;

FIG. 2 shows an example high level architecture of a wireless communications system;

FIG. 3 is an example flowchart for transmission time interval (TTI) bundling;

FIG. 4 is an example flowchart for transmission time interval (TTI) bundling; and

FIG. 5 is an example flowchart for transmission time interval (TTI) bundling.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

When referred to hereafter, the terminology “TTI bundling”, “bundled transmission”, and “autonomous retransmissions” are used interchangeably and they refer to the transmission of a data packet with at least one consecutive autonomous retransmission. They may also refer to the transmission of a data packet using an integer number (larger than 1) of transmission time intervals (TTI), wherein the TTIs may not necessarily be repeated.

Although the methods and apparatus are described herein in the context of the Third Generation Partnership Project's (3GPP) wideband code division multiple access (WCDMA) systems, it should be understood to one skilled in the art that the methods and apparatus described herein are also applicable to any wireless communications system that may support autonomous retransmissions, such as Long Term Evolution (LTE) or Worldwide Interoperability for Microwave Access (WIMAX).

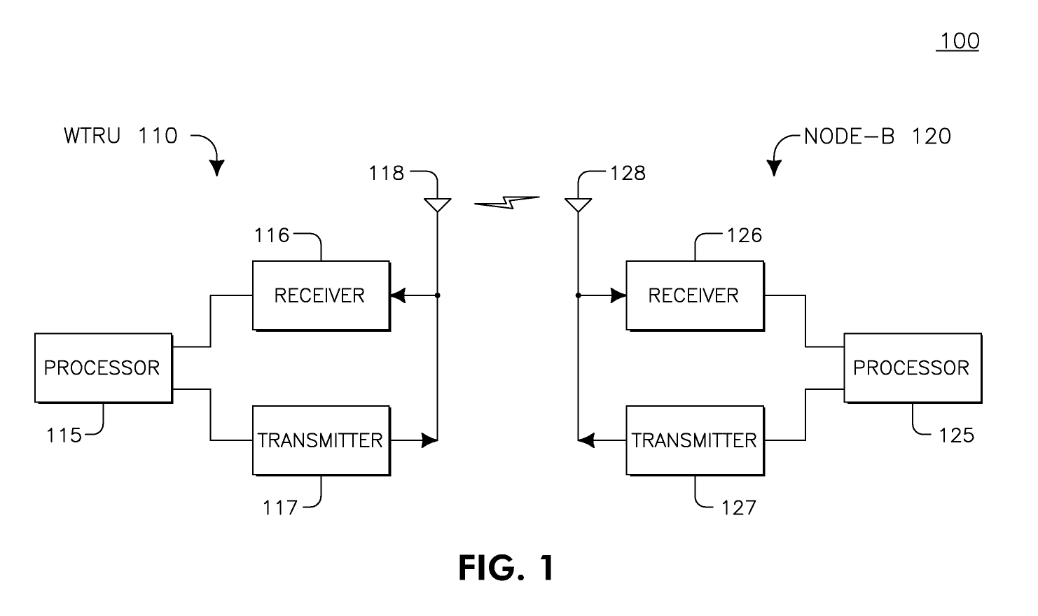

FIG. 1 is a wireless communication system 100 including, but not limited to, functional block diagrams of a wireless transmit/receive unit (WTRU) 110 and a base station 120 (shown for example as a Node-B). As shown in FIG. 1, the WTRU 110 is in communication with the base station 120 and both are configured to perform a method of transmission time interval (TTI) bundling.

In addition to the components that may be found in a typical WTRU 110, the WTRU 110 includes a processor 115, a receiver 116, a transmitter 117, and an antenna 118. The processor 115 is configured to perform a method of transmission time interval (TTI) bundling in the WTRU 110. The receiver 116 and the transmitter 117 are in communication with the processor 115. The antenna 118 is in communication with both the receiver 116 and the transmitter 117 to facilitate the transmission and reception of wireless data.

In addition to the components that may be found in a typical base station, the base station 120 includes a processor 125, a receiver 126, a transmitter 127, and an antenna 128. The processor 125 is configured to perform a method of transmission time interval (TTI) bundling in the WTRU 110. The receiver 126 and the transmitter 127 are in communication with the processor 125. The antenna 128 is in communication with both the receiver 126 and the transmitter 127 to facilitate the transmission and reception of wireless data.

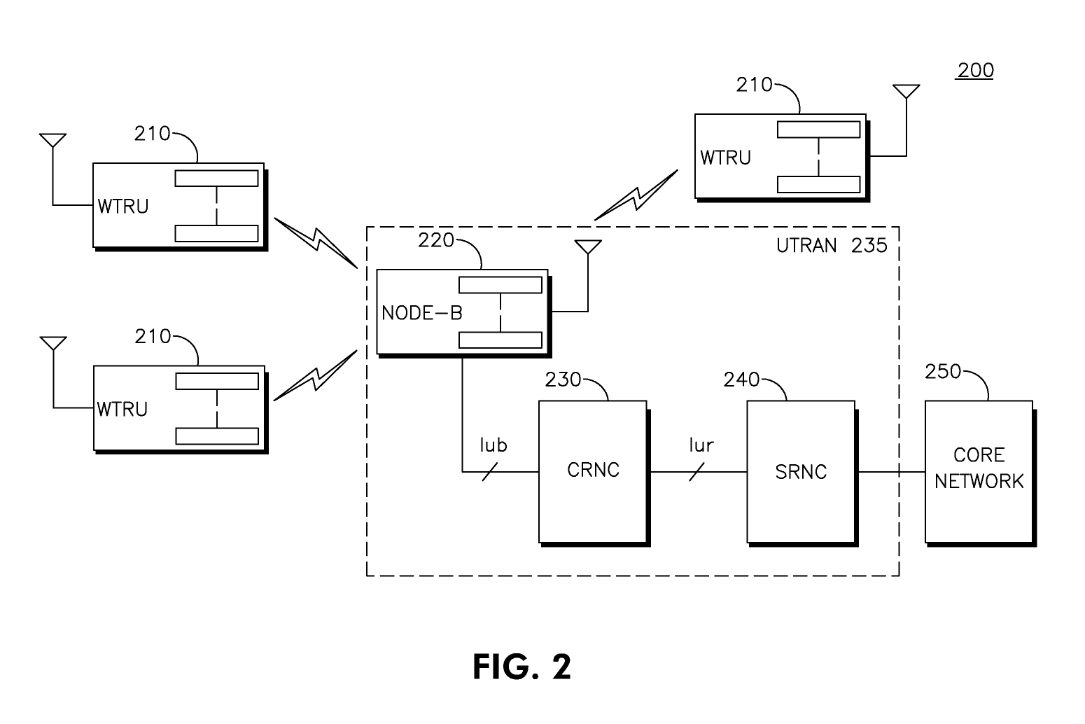

FIG. 2 shows a wireless communication system 200 including a plurality of WTRUs 210, a base station 220, a controlling radio network controller (CRNC) 230, a serving radio network controller (SRNC) 240, and a core network 250. The base station 220, the CRNC 230 and the SRNC 240 may collectively be referred to as the UTRAN 235.

As shown in FIG. 2, the WTRUs 210 are in communication with the base station 220, which is in communication with the CRNC 230 and the SRNC 240. Although three WTRUs 210, one base station 220, one CRNC 230, and one SRNC 240 are shown in FIG. 2, it should be noted that any combination of wireless and wired devices may be included in the wireless communication system 200.

The following discussion presents a WTRU 210 and a base station 220 that are configured to process signaling methods and/or configuration messages and procedures that enable the activation, deactivation and configuration of the TTI bundling mode as controlled by the UTRAN 235 and then as controlled by the WTRU 210. WTRU 210 behavior is also presented with respect to both control perspectives.

A radio network, such as for example, the UTRAN 235, may control the use of TTI bundling by the WTRU 210. This control may be achieved by sending several different types of control information, examples of which are provided herein.

In an example method, the UTRAN 235 may indicate to the WTRU 210 to start TTI bundling at the next transmission opportunity and for all subsequent transmission opportunities until it receives a command to stop TTI bundling.

In another example, the UTRAN 235 may indicate to the WTRU 210 to start TTI bundling at the next transmit opportunity and for all subsequent transmission opportunities until a predetermined criteria is met.

In another example, the UTRAN 235 may indicate to the WTRU 210 the number of autonomous retransmissions a WTRU 210 may use for its next transmit opportunity. A value of 0 may be used to indicate not to use TTI bundling.

In another example, the UTRAN 235 may indicate to the WTRU 210 the number of autonomous retransmissions the WTRU 210 should use for each HARQ process. If the number of autonomous retransmissions is the same for each HARQ process, a single enumerated value (i.e., number of autonomous retransmissions) may be configured (for example 0, 1, 3, 7 or any other applicable value). The WTRU 210 may then identify based on the number of autonomous retransmissions which HARQ processes will remain active. For example, if the number of autonomous retransmissions is 0, 1, 3, or 7, the active HARQ processes will correspond to all, [0,2,4,6], [0,4] and 0, respectively.

In another example, the UTRAN 235 may indicate to the WTRU 210 the maximum number of autonomous retransmissions the WTRU 210 should use. The actual number of autonomous retransmissions that the WTRU 210 performs for a given medium access control (MAC-e) or MAC-i protocol data unit (PDU) may depend on the enhanced data channel (E-DCH) transport format combination (E-TFC) selection procedure and/or on the available power margin.

In another example, the UTRAN 235 may indicate to the WTRU 210 the HARQ processes to be used for initial transmissions. The WTRU 210 may implicitly determine that the HARQ processes not listed or indicated may be used for autonomous retransmission and appropriately deactivate or disable them. Alternatively the UTRAN 235 may indicate to the WTRU210 the HARQ processes that are to be deactivated so that autonomous retransmissions may be used instead.

In another example, the UTRAN 235 may indicate to the WTRU 210 a TTI bundling activation time. The activation time may also be provided by the radio network controller (RNC) to all neighboring base stations 220.

In another example, the UTRAN 235 may indicate to the WTRU 210 to activate TTI bundling at the first TTI or the first HARQ process (for example, HARQ process ID “0”).

The TTI bundling commands, control information and/or configuration messages (these terms being used interchangeably herein) may be signaled to the WTRU 210 via, for example, Layer 1 (L1), Layer 2 (L2), Layer 3 (L3) or any combination thereof.

In an example L1 signaling method, the UTRAN 235 may use the enhanced absolute grant channel (E-AGCH) to convey TTI bundling commands that are described herein by using a new E-AGCH structure defined for this purpose or changing the function or interpretation of predetermined fields in the existing E-AGCH.

For example, a portion of the absolute grant value field may be used to carry the number of autonomous retransmissions that a WTRU 210 may use. In another example, a reserved value of the WTRU 210 grant field may be defined and used to activate/deactivate TTI bundling. In another example, the absolute grant scope field may be used to indicate to the WTRU 210 to activate/deactivate TTI bundling. For instance, if TTI bundling mode is configured, the “per HARQ process” value may be re-interpreted to mean that TTI bundling should be activated.

In another example, the interpretation of a setting of “INACTIVE” in the absolute grant value field may change when the WTRU 210 is configured to operate in TTI bundling mode and when absolute grant scope is set to “per HARQ process”. For example, “INACTIVE” may represent that HARQ processes (e.g., the TTI corresponding to this HARQ process) cannot be used for an initial transmission, but may be used for autonomous retransmissions. In an alternative interpretation, a value of “INACTIVE” and “per HARQ process” may signal to the WTRU 210 to activate TTI bundling at this HARQ process.

In another example, a “zero grant” setting in the E-AGCH may indicate that the HARQ process may not be used for initial transmission when the absolute grant scope is set to “per HARQ process” and that the TTI corresponding to the HARQ process may be used only for autonomous retransmissions.

In another example, the WTRU 210 may be assigned a special enhanced radio network temporary identifier (E-RNTI) value. When the E-AGCH is masked with the special E-RNTI value, the WTRU 210 implicitly knows that this command is used for autonomous retransmission and the E-AGCH structure or bit interpretation is as described herein. In yet another example, a normal interpretation of the E-AGCH may be used, but if the E-AGCH is masked with the special E-RNTI, this may be used as an indication to the WTRU 210 to enable autonomous retransmission with a configured value that has been provided to the WTRU 210 previously. The same method may be used to disable autonomous retransmissions.

In a further L1 signaling example, a new L1 channel may be defined to convey any of the TTI bundling commands described herein.

In a L1 signaling example, the use of L1 to control TTI bundling may facilitate, but not force, the UTRAN 235 to control the use of TTI bundling on a per-TTI basis.

In yet a further L1 signaling example, an HS-SCCH order may be used to provide information regarding activating/deactivating or enabling/disabling the TTI bundling operation, the HARQ process ID to apply to the TTI bundling, and/or the number of retransmissions per HARQ process. In an example method, if all HARQ processes are configured to have the same number of autonomous retransmissions, a two bit field may be used to indicate an index to the number of retransmissions (0, 1, 3, 7). The HS-SCCH order signaling may be implemented using the example method where the Order Type bits are labeled x_{odt,1}, x_{odt,2}, x_{odt,3} and the Order bits are x_{ord,1}, x_{ord,2}, x_{ord,3}. A new order is defined for TTI bundling, in this example, the Order Type x_{odt,1}, x_{odt,2}, x_{odt,3}=‘010’. For the TTI bundling order type, the mapping for x_{ord,1}, x_{ord,2}, x_{ord,3}, where the order may be used to activate/deactivate the TTI bundling according to a preconfigured pattern or according to a pattern determined by the WTRU 210, may be as follows:
x_{ord,1}, x_{ord,2}, x_{ord,3} is comprised of:
   Reserved (2 bits): x_{ord,1}, x_{ord,2}=x_{res,1}, x_{res,2}
   TTI bundling activation (1 bit): x_{ord,3}=x_{TTI}_{_{—}}_{bundling,1}
If x_{TTI}_{_{—}}_{bundling,11}=‘0’ then the HS-SCCH order is a TTI bundling de-activation order.
If x_{TTI}_{_{—}}_{bundling,1}=‘1’ then the HS-SCCH order is a TTI bundling activation order.

In another example, the 2 reserved bits may be used to provide additional information to the WTRU 210, such as the TTI bundle size or the maximum TTI bundle size, which is the number of TTIs that are to be bundled in the TTI bundle. For example, one or a combination of the following interpretations may be used
x_{ord,1}, x_{ord,2}=x_{bundlesize,1}, x_{bundlesize,2}:
If x_{bundlesize,1}, x_{bundlesize,2}=‘00’ then the bundle size is 1 (i.e. no TTI bundling or repetition)
If x_{bundlesize,1}, x_{bundlesize,2}=‘01’ then the bundle size is 2
If x_{bundlesize,1}, x_{bundlesize,2}=‘10’ then the bundle size is 4
If x_{bundlesize,1}, x_{bundlesize,2}=‘11’ then the bundle size is 8

In such deployments, the HARQ processes that are allowed for initial transmission are preconfigured depending on the TTI bundle size.

In an example L2 signaling method, new signaling may be used to control the use of TTI bundling at the WTRU 210. For example, a header field may be included in the MAC-ehs or MAC-hs header to indicate activation/deactivation of TTI bundling or to command the WTRU 210 to use a given number of autonomous retransmissions.

In another example, a special value of the Logical Channel ID (LCH-ID) may be used to indicate to the WTRU 210 that control information on TTI bundling follows at the end of the payload. In yet another example, 4 bits may be available in the header, for byte alignment purposes, following the LCH-ID. These 4 bits may be used to indicate to the WTRU 210 that the TTI bundling may be enabled or disabled by setting the bits to 0000 or 0001 respectively. The other values may be reserved for other purposes. Alternatively, a predetermined value of the 4 bits may be reserved to indicate that the payload contains TTI bundling information.

In an example L3 signaling method, the UTRAN 235 may configure, activate and deactivate the use of TTI bundling at the WTRU 210 using radio resource control (RRC) signaling. For example, new or modified information elements (lEs) may be used, such as Radio Bearer Configuration/Reconfiguration or Transport channel configuration/reconfiguration messages. In an example, the IE “E-DCH info”, used to configure E-DCH operation, may be extended to provide the TTI bundling information. Alternatively, RRC control messages may be used. For example, the RRC message may provide an activation time to the WTRU 210 and at the given activation time, a WTRU 210 may enable or disable TTI bundling. The activation time may be provided to a neighboring base station, which allows for full synchronization between the WTRU 210 and all base stations in the active set.

In a further example, the RRC message may be used to configure a WTRU 210 with the TTI bundling pattern. For instance, the WTRU 210 may receive information regarding the number of HARQ process IDs, the number of retransmissions per HARQ process IDs if it is different on a per HARQ process level, or any of the other signaling information discussed herein.

In another example, the TTI bundling pattern and activation/deactivation of TTI bundling may be configured via L3 or RRC signaling. The WTRU 210 may not use the pattern until the UTRAN 235 signals to the WTRU 210 to activate the configured TTI bundling mode. The activation/deactivation signaling may be provided using any of the L1, L2 or L3 methods discussed herein.

For example, when L1 or L2 signaling is used to activate/deactivate TTI bundling in the WTRU 210, the serving base station, signals to the non-serving base station that such order has been sent. This may be done, for example, via the lub/lur interface. The signaling or indication, may be sent as soon as the order is sent, or alternatively, only once the acknowledgement (i.e., HARQ ACK) on the TTI bundling activation/deactivation order (or MAC PDU, in case of L2 signaling) is received.

In another example, when L1 or L2 signaling, is used to activate/deactivate TTI bundling, the WTRU 210 may be configured to act on the order X TTIs from the reception of the message, where X may be a predefined value. X may be set such that it allows enough time to send an acknowledgment to the base station 220, and, optionally, such that the other non-serving base stations are notified that the serving base station sent such an order.

In an example method, if the network, e.g., the UTRAN 235, configures a WTRU 210 to use MAC discontinuous transmission (DTX), the WTRU 210 may determine the TTI bundling pattern based on the MAC DTX (for example, using the enhanced uplink dedicated transport channel (E-DCH) start time restriction). For example, the parameter, MAC Inactivity Threshold, may be set to 1 so that the WTRU 210 may not transmit HARQ processes (implicitly defined by the DTX pattern) regardless of the traffic activity. The WTRU 210 may use the inactive HARQ processes for autonomous retransmissions. The MAC DTX may continue (i.e., enhanced transport format combination (E-TFC) selection occurs on the TTIs defined by the MAC DTX feature, and thus on the corresponding HARQ processes). However, as stated herein, the WTRU 210 may be able to perform autonomous retransmissions on the inactive HARQ processes.

Further to this example, the WTRU 210 may be signaled to use the inactive HARQ processes' TTI for autonomous retransmission only, by setting an inactivity threshold equal to 1. If an inactivity timer is larger than one (the inactivity threshold), the WTRU 210 may not use the inactive HARQ processes to transmit retransmissions. In another example, the WTRU 210 may not always use the DTX pattern. The network, for example, the UTRAN 235, may have the option to indicate to the WTRU 210 when to start using the MAC DTX pattern for autonomous retransmissions by using one of the activation/deactivation methods described herein.

In another example, the WTRU 210 may be configured to autonomously decide to start TTI bundling according to the MAC DTX pattern (if DTX is active) in accordance with a defined condition. More specifically, if the WTRU 210 is configured with TTI bundling (either L3 configured or activated via L1 or L2), and with MAC DTX as described herein, and if predetermined conditions are met, then the WTRU 210 may perform TTI bundling. The first transmission occurs on the active HARQ process and the retransmissions are performed on the following TTIs corresponding to the DTX-ed HARQ processes. The WTRU 210 may signal the base station 220 of TTI bundling on this deactivated process, or alternatively, just transmit using normal E-DCH signaling and the base station 220 determines that these are retransmissions since it is receiving data on the TTIs corresponding to deactivated HARQ processes. When the conditions are not met, the WTRU 210 only performs one transmission on the active HARQ process.

In an example method, a WTRU 210 may be configured to have some control regarding when to use TTI bundling. This may be done via procedures that dictate to the WTRU 210 when it should use TTI bundling and when it should not. For example, these procedures may either be predetermined or they may be configured by the UTRAN 235. This may also apply to a RRC configured TTI bundling pattern or to HARQ process IDs.

A number of example methods that the WTRU 210 uses to control TTI bundling operation relies on some criteria that the WTRU 210 may need to verify before triggering the TTI bundling operation or deciding to perform retransmissions. For example, such criteria or triggers may include, but are not limited to, the E-TFC for the next transmission being smaller than a given value, the running average of the E-TFC, or any other calculated metric based on E-TFC of past transmissions that may be determined to be below a predetermined value.

Other criteria may include the WTRU 210 not having enough power to transmit or the WTRU 210 being in power limited scenarios or the WTRU 210 being in cell edge conditions. This may be determined according to uplink power headroom (UPH), the instantaneous uplink power headroom (e.g., averaged over the TTI) being below a given value, the running average of the UPH, or any other calculated metric based on the UPH of past transmissions.

Another example criterion for determining power limitation is if the normalized remaining power margin (NRPM) is above or below a predetermined configured value.

Another example criterion for determining power limitation is when the WTRU 210 does not have enough power to transmit any of the configured E-TFCI (or the remaining power margin is not sufficient to transmit any of the configured E-TFCIs) and is making use of the minimum set E-TFCI, due to power limited situations. More specifically, as part of the E-TFC selection, the WTRU 210 may be configured to perform E-TFC restriction for a target E-DCH TTI, and determines the normalized remaining power margin (NRPM). If NRPMⱼ<Σ(β_{ed,j}/β_{c})² (or NRPMⱼ<Σ(β_{d,C,j}/β_{c,C})² wherein the target E-DCH TTI for which E-TFC restriction is being considered belongs to a compressed mode frame) then E-TFCⱼ, where E-TFCⱼ correspond to the lowest configured E-TFC, is not supported. In this case, the only E-TFCI that the WTRU 210 will consider, as a supported E-TFC, is the E-TFCI value signaled in the minimum set E-TFCI. The WTRU 210 is configured to autonomously initiate TTI bundling for this transmission. If in the next HARQ process, for which E-TFC selection is performed, this condition persists, the WTRU 210 continues TTI bundling. The WTRU 210 performs one transmission (no TTI bundling) on the target E-DCH TTI for which that condition is not met. β_{ed,j}/β_{c} and β_{ed,C,j}/β_{c,C} is the quantized amplitude ratio.

Another example criterion for determining that the WTRU 210 is power limited is if the total WTRU 210 transmit power (optionally, after applying DPCCH power adjustments and gain factors) exceeds the maximum allowed value.

Another example criteria may include, but are not limited to, determining if metrics such as channel quality index (CQI) or received symbol strength indicator (RSSI) are below, or estimated path loss is above, a given or predetermined value. Running averages may be used as well in another example method.

In another example method, the common pilot channel (CPICH) measurements of received signal code power (RSCP) or Ec/No may be determined to be below or above a configured threshold. Similarly, the running average of the RSCP or Ec/No may be used in still another example.

Another example criterion may be metric based on the set of E-TFCs in a blocked state. For example, the index of the smallest E-TFC in the blocked state may be equal to, below or above a configured threshold. Similarly, the set of E-TFCs in blocked state may include a configured, or a set of configured E-TFCs.

Another example criterion may be the highest priority logical channel or MAC-d flow, for the TTI in which E-TFC selection is being performed, that belongs to a list of allowed logical channels or allowed MAC-d flows for TTI bundling. More specifically, the network may explicitly indicate to the WTRU 210 the MAC-d flow or logical channels for which TTI bundling is allowed, via RRC configuration messages.

Another example criterion may be that the logical channel priority or the MAC-d flow priority level belongs to a TTI priority level. More specifically, the WTRU 210 may be configured to allow logical channels or MAC-d flow with a priority higher (or lower) than a configured or predetermined threshold to perform TTI bundling.

Another example criterion may be that the transmission on the TTI being considered corresponds to a non-scheduled or scheduled flow. As such, the WTRU 210 may be preconfigured to only perform TTI bundling on non-scheduled flows or only on scheduled flows. Alternatively, this choice may be network configurable.

Another example criterion may be that the HARQ process is reserved for TTI bundling. For example, HARQ process 0 and 4 are reserved for TTI bundling operation. The decision on whether to perform autonomous retransmission may be based on one of the combinations described herein. The other HARQ processes may be used for normal transmission if no autonomous retransmissions are taking place at that TTI.

Once a TTI bundling criteria as described herein has been verified by the WTRU 210, the behaviors dictated by the TTI bundling procedures may include, for example, the WTRU 210 sending measurements to the UTRAN 235 to facilitate the decision-making process of the UTRAN 235 in regard to the use of TTI bundling. The WTRU 210 may be configured to send a set of measurements or indicators when one of the TTI bundling criteria is met. This information may then be used by the UTRAN 235 to determine if it should configure or activate/deactivate the WTRU 210 to operate in TTI bundling mode. The measurement report may consist of but is not limited to scheduling information (SI), a MAC-i PDU (using the reserved value of the LCH-ID and one of the values of the 4 following bits) or any other set of measurements. The measurement report may be carried via L1, L2 or RRC signaling. A new measurement event, using one of the criteria defined herein, may be configured via a measurement control message. When the measurement criterion or criteria is met, a measurement report may be triggered.

The WTRU 210 may also be configured to decide, on a per-TTI basis, if a given transmission should be sent using TTI bundling. The WTRU 210 may send the upcoming transmission using TTI bundling if the given TTI bundling criteria or trigger is met.

The WTRU 210 may also be configured to decide if it should start or stop operating in a mode where it sends all subsequent transmissions using TTI bundling. This may be done using any of a number of methods, examples of which are discussed herein. For example, the WTRU 210 may be configured to verify if a given TTI bundling criteria is met on a TTI-basis. It may be done periodically, triggered by other triggering criteria or signaled from the UTRAN 235. If the TTI bundling criterion is met, the WTRU 210 may send the upcoming transmission and all subsequent transmissions using TTI bundling until the subsequent verification of the TTI bundling criteria triggers the WTRU 210 to deactivate TTI bundling mode.

In another example, the WTRU 210 may be configured to decide if it should start or stop operating in a mode where its sends all subsequent transmissions using TTI bundling. Accordingly, when the WTRU 210 verifies if a given TTI bundling criteria is met, it is not done on a TTI-basis. It may be done periodically, triggered by another triggering criteria, or signaled from the UTRAN 235. If the TTI bundling criteria is met, the WTRU 210 sends the upcoming transmission and all subsequent ones using TTI bundling until the subsequent verification of the TTI bundling criteria triggers the WTRU 210 to deactivate TTI bundling mode.

In another example, the network, for example the UTRAN 235, configures the WTRU 210 to operate with TTI bundling. This configuration may be an L3 RRC configuration, where at least the WTRU 210 is made aware that the network also supports TTI bundling, and a list of possible configurations may be provided to the WTRU 210. Once configured with L3 signaling, the WTRU 210 may decide to perform bundling on a TTI basis, wherein the WTRU 210 determines whether the conditions or triggers described are met prior to originating an initial transmission on the given HARQ process.

In another example, once the WTRU 210 is configured with TTI bundling via L3, L1 or L2 signaling may be used to dynamically and/or explicitly signal whether the WTRU 210 should activate TTI bundling. When this activation signaling is received, the WTRU 210 determines whether TTI bundling should be applied in the next upcoming transmission based on the conditions described herein. Once L1 or L2 deactivates TTI bundling, the WTRU 210 continues normal E-DCH operation.

In another example, once the WTRU 210 is configured for TTI bundling, and TTI bundling is activated (via L3, L2 or L1 signaling), the WTRU 210 deactivates the HARQ processes that correspond to autonomous retransmissions. Upon deactivation of TTI bundling, the WTRU 210 may return to its previous configuration (i.e., the processes that were activate before TTI bundling was enabled are reactivated).

In order to assist the network, for example the UTRAN 235, in dynamically activating/deactivating TTI bundling, the WTRU 210 may be configured to send an SI when one of the criteria is met. More specifically, the SI triggering criteria may be modified such that an SI is triggered when the UPH is below a configured or predetermined threshold. The trigger may also include the condition that the total E-DCH buffer status (TEBS) has to be different than zero in order to trigger the SI.

In another example, when the network receives the UPH value in the SI, the network may decide to activate TTI bundling using one of the methods described herein. Additionally, if the UPH goes above a predetermined threshold while TTI bundling is ongoing, the WTRU 210 may trigger another SI, which in turn may assist the network in deciding to deactivate TTI bundling using one of the methods described herein.

Whether the control of the use of TTI bundling by a given WTRU 210 is partially or fully retained by the UTRAN 235 or the WTRU 210, the WTRU 210 may need to communicate to the base station 220 and to the non-serving base stations that the WTRU 210 is operating in TTI bundling mode.

For example, this may occur when the WTRU 210 has autonomously determined to start or to stop using TTI bundling. This may also occur when the UTRAN 235 has configured the WTRU 210 to start or stop operating in TTI bundling mode, but the actual start time of such change is not known by the UTRAN 235. This may also occur when the WTRU 210 is operating in soft handover and the non-serving cell (non-serving base station) has not determined that a WTRU 210 is using TTI bundling when the command to use TTI bundling has been communicated to the WTRU 210 by the serving cell (serving base station). This may occur when the WTRU 210 has been signaled to start, but the WTRU 210 decides to finish transmission of the HARQ processes that will become inactive prior to initiating TTI bundling. This may also occur when TTI bundling has been activated or signaled to the WTRU 210, but the WTRU 210 will only perform bundling if the triggers or conditions outlined herein are met.

TTI bundling notification may include information that characterizes the use (or lack of use) of TTI bundling by the WTRU 210. For example, the notification may be an indicator as to whether or not a given transmission is sent using TTI bundling, the number of autonomous retransmissions the WTRU 210 is using, and/or an indicator that all transmissions following the indication or signaling will be using the TTI bundling pattern configured by the network (e.g., the UTRAN 235) or decided by the WTRU 210 and signaled using one of the methods described herein. The notification may also be an indication whether the current transmission is a first transmission or a subsequent transmission of the TTI bundle.

The TTI bundling notification sent to the UTRAN 235 may be signaled at L1, L2 or L3 by the WTRU 210.

The methods by which a WTRU 210 signals TTI bundling notification to the UTRAN 235 may be split into two general categories. In the first category, the WTRU 210 may first convey the information as to the use of TTI bundling on a per-TTI basis. Alternatively, the WTRU 210 may use the same signaling methods described herein to convey an indication that the WTRU 210 has started or stopped transmitting in TTI bundling mode. The WTRU 210 does not need to notify the UTRAN 235 at every transmission. Notification may occur when the WTRU 210 starts or stops using TTI bundling.

In the second category, the WTRU 210 may notify the UTRAN 235 that the WTRU 210 will use TTI bundling for a given amount of time, for a pre-determined number of transmissions or until the WTRU 210 notifies the UTRAN 235 that it will stop using TTI bundling.

The WTRU 210 may be configured to implement the following example signaling methods that allow the WTRU 210 to convey to the UTRAN 235, on a TTI-basis, the TTI bundling notification. The example methods described herein may be used individually or in any combination. For example, the WTRU 210 may indicate on a per TTI basis whether it is using TTI bundling once there has been a signal to activate the use of TTI bundling using any of the methods described in this disclosure.

In an example, the WTRU 210 may use a reserved value of some existing enhanced downlink physical control channel (E-DPCCH) field or high speed downlink physical control channel (HS-DPCCH) field (for example, channel quality index (CQI), or E-DCH transport format combination indicator (E-TFCI)) to indicate to the UTRAN 235 that the associated on-going transmissions uses TTI bundling. In another example, 5 or 6 bits from the E-TFCI field signals the actual E-TFCI and with the remaining bits indicates if the WTRU 210 is performing TTI bundling. At cell edge conditions, the WTRU 210 does not use the full range of E-TFCI. Only the lower transport blocks sizes will be used by the WTRU 210 so a 7 bit E-TFCI field is not required.

The WTRU 210 may be configured to use the following example signaling methods to permit the WTRU 210 to signal the UTRAN 235, on a TTI-basis, the TTI bundling notification. In an example, a new E-DCH transport block size table may be configured, or only a subset (e.g., the lower part indexed by the first 5 or 6 bits) of an existing E-DCH transport block size table may be used. For example, a value of zero may mean that the WTRU 210 is not performing TTI bundling, and a value of 1 may indicate that TTI bundling is being performed. Alternatively, a value of zero may imply that this is a first transmission, and for any subsequent retransmission the WTRU 210 signals a value of 1, to indicate that these are retransmissions of the same TTI bundle. In a further example, the two extra bits are used to indicate the HARQ process to which the transmission belongs. This may allow the base station 220 to determine the HARQ process in which the data should be combined without necessarily knowing the TTI bundle size. The values indicated by the two bits (0,1,2,3) may implicitly refer to HARQ process (0,2,4,6) respectively.

The WTRU 210 may use a re-interpretation of the Happy Bit as a TTI bundling notification/indication bit.

The WTRU 210 may use, in another example method, a TTI bundling notification/indicator field is added to the E-DPCCH, which may require adding another basis to the (32,10) Reed-Muller code currently used for E-DPCCH encoding. A new masking sequence may be designed to minimize the probability of making an incorrect decision on the TTI bundling indication regardless of the value taken by the other information bits.

The WTRU 210 may use, in another example method, a new channel is created that may convey such information to the base station 220. This new channel may, for example, only be setup when the WTRU 210 is in a position where it may need Enhanced Uplink Coverage, and/or when the WTRU 210 is configured to operate in TTI bundling mode. A special sequence of symbols may be transmitted over the E-DPCCH (instead of the actual E-DPCCH information). For example, this special sequence may be transmitted for configured subsets of TTIs during the bundle. During the other TTIs, the regular E-DPCCH is transmitted. For special cases, for the first TTI in a TTI bundle, the E-DPCCH with the special sequence is transmitted. The other TTIs carry the regular E-DPCCH. In another example, the first and last TTI in a TTI bundle carry the E-DPCCH with the special sequence while the other TTIs carry the regular E-DPCCH. In another example, a different configured power-offset may be used on the E-DPCCH to carry the special sequence. This power-offset may optionally be used throughout the TTI bundle. In another example, this special sequence may be designed to have a large Hamming distance (or other metric) with all possible values and that the current E-DPCCH (with the Reed-Muller encoding) may take.

The WTRU 210 may use in another example method, 3 bits from the E-DPCCH to indicate the HARQ process ID. This may allow the WTRU 210 to perform asynchronous transmission and perform TTI bundling on any HARQ process. The three bits to be used may result from a change of the E-DPCCH E-TFCI field (i.e., reducing the number of bits of the E-TFCI to 4), or alternatively, reducing the size of the E-TFCI and the RSN field. The 3 bits may also be added to the E-DPCCH channel.

Any reinterpretation of bits may be possible once the base station 220 or RNC signals to the WTRU 210 that it may start TTI bundling (without a given indication time). All of the base stations 220 are then made aware of the re-interpretation of these bits. The different re-interpretation of control channel (e.g., E-DPCCH) information bits may optionally be linked to a configured subset of HARQ processes. In such cases, both the network and WTRU 210 know which control channel format to use for a given HARQ transmission. The presence or absence of a transmission from a previous HARQ process, or the presence or absence of a specific indication carried over the (e.g., E-DPCCH) control channel in a previous TTI may also indicate which control channel format or interpretation to use in the upcoming HARQ processes. For example, the network may configure the WTRU 210 such that HARQ process 0 uses a new interpretation of the E-DPCCH bits. Depending on the transmission or absence of transmission in HARQ process 0, the following HARQ processes (e.g., 1, 2, and 3 for instance) may implicitly use one or the other E-DPCCH interpretation. This may be used for instance to avoid reserving HARQ processes for autonomous retransmissions.

Continuing with the example, if a HARQ transmission occurs in HARQ process 0, then the following HARQ processes (e.g., 1, 2 and 3) may be used by the WTRU 210 for autonomous retransmissions and the alternate interpretation of the control channel bits (e.g., E-DPCCH) is used. Otherwise no autonomous retransmissions are used and the legacy interpretation of the E-DPCCH bits may be used by both the network and WTRU 210.

As another example of how the E-DPCCH bits may be re-interpreted when the WTRU 210 is configured to use TTI bundling, the retransmission sequence number (RSN) value may indicate whether or not the current TTI is part of a TTI bundle. For example, the value RSN=3 may be reserved for E-DPCCH transmitted along TTI bundles only. A new redundancy version mapping may then be defined as shown in Table 1. The WTRU 210 may then transmit RSN value 2 for the second HARQ retransmissions and over.

TABLE 1
Relation between RSN value and E-DCH RV Index
when WTRU is configured for TTI bundling

| RSN | N_{sys}/N_{e,data,j} < ½ | ½ ≦ N_{sys}/N_{e,data,j} |
|---|---|---|
| Value | E-DCH RV Index | E-DCH RV Index |
| 0 | 0 | 0 |
| 1 | 2 | 3 |
| 2 | [└TTIN/N_{ARQ}┘ mod 2] × 2 | └TTIN/N_{ARQ}┘ mod 4 |
| 3 | 0 | 0 |

This arrangement may be used, for example, when there is no HARQ retransmission of a TTI bundle. That way there is no ambiguity as to whether or not the transmitted TTI bundle is a new transmission or a HARQ retransmission (as it is not transmitting RV=0). It should be noted that the entries in Table 1 may be changed, for example, to ensure that the second or third transmission prioritize the systematic bits. Also, the RV index within a TTI bundle may also change implicitly without being explicitly signaled.

In this example, the E-TFCI bits and the Happy Bit mapping may remain unchanged. Alternatively, when the special value of RSN indicates a TTI bundle is used, a different interpretation of the E-TFCI bits field and HappyBbit may be used. For example, as suggested herein, the E-TFCI field may be reduced to 5 or 6 bits in this case and the 1 or 2 extra bits may be used to signal additional information, such as, the TTI bundle size or whether the TTI bundle is a new transmission, which may allow HARQ retransmission of TTI bundles.

In another example, the E-TFCI and Happy Bit fields are set to fixed and known values when the special value of RSN is used. This allows the WTRU 210 to reduce the transmission power of the E-DPCCH for the same detection performance at the base station 220. The amount by which the E-DPCCH power is reduced in that case may be pre-defined or signaled by higher layers.

The WTRU 210 may be configured to use L2 signaling to control the use of TTI bundling by a WTRU 210. For example, a header field may be included in the MAC-e, MAC-es, MAC-i or MAC-is header to indicate activation/deactivation of TTI bundling or to indicate the number of autonomous retransmissions the WTRU 210 is using. Alternatively, a special value of the LCH-ID may be used to so that the subsequent four bits may be used to convey that TTI bundling has been activated or deactivated in the WTRU 210 for all subsequent transmission. One of the reserved values of the four bits may be used to indicate activation and another one to indicate deactivation. Alternatively, one of the values of the reserved bits may indicate that the payload contains TTI bundling information that the WTRU 210 is intending to use.

Alternatively, the WTRU 210 may send a reserved value of the SI to indicate activation/deactivation of TTI bundling. The L2 messages may be received by all base stations 220. Therefore, the base stations 220 may be aware that the WTRU 210 is initiating TTI bundling.

The WTRU 210 may ensure that the MAC-i PDU containing the information using any of the methods described herein is acknowledged by all base stations 220. To increase the probability that all base stations 220 receive the information the WTRU 210 may transmit the SI or other signal at a higher power than for a normal transmission (e.g. may use a power offset).

The WTRU 210 may also convey a TTI bundling notification to the UTRAN 235 using RRC signaling. For example, this may be achieved by adding new or modifying existing lEs in existing RRC control messages such as Radio Bearer Configuration/Reconfiguration Confirm or a transport channel/physical channel configuration/reconfiguration confirm message. Alternatively, it may be achieved using new RRC control messages. The WTRU 210 may indicate the activation time (CFN) in which it intents to start TTI bundling information to the network. The RNC may then provide this information to all base stations 220 in the active set.

If the WTRU 210 uses MAC DTX as an indication to start TTI bundling, there may be no need to signal the initiation of autonomous retransmissions. The base stations 220 may monitor the TTIs in which the HARQ processes are deactivated for MAC DTX. When data is received over these TTIs, the base stations 220 may implicitly detect that the protocol data units (PDUs) are retransmissions of the active HARQ processes.

The WTRU 210 may also use a normal HARQ transmission on the current HARQ process for the first transmission. If for the next transmission on this HARQ process the WTRU 210 has to perform a retransmission, the WTRU 210 re-evaluates the above mentioned condition to determine whether it may send the retransmission using TTI bundling, and if the conditions are met, the WTRU 210 performs TTI bundling.

A WTRU 210 method and implementation thereof is disclosed for indicating the presence of a bundled transmission or normal HARQ transmission. In this example method, a subset of known sub-frames is semi-statically configured to always use a special E-DPCCH format which indicates information relevant to TTI bundling. Such E-DPCCH format may include the information fields as described herein. One of the information fields may indicate whether bundled retransmissions or normal HARQ transmissions will occur in subsequent sub-frames. Because the reserved sub-frames are using a special E-DPCCH format, restrictions as to the type of data or the logical channels from which data may be taken for transmission in these sub-frames may be defined. For example, data from the logical channel including the Voice over IP (VoIP) traffic to be transmitted in the reserved sub-frames may only be allowed. Alternatively, the restriction may be in terms of the maximum transport block size on this process. This allows the use of fewer bits for the E-TFCI.

In the remaining subset of sub-frames, either the normal (legacy) E-DPCCH format or the special E-DPCCH format may be used depending on whether the sub-frame is used to transmit a bundled transmission or a normal HARQ transmission from the HARQ process that should normally be used for synchronous HARQ timing. The base station 220 may detect whether a bundled or normal transmission is taking place based on either blind detection of the E-DPCCH format, detection of the power ratio between E-DPCCH and DPCCH (which may be different between the special E-DPCCH format and legacy E-DPCCH format), or an indication that bundling has occurred from the special E-DPCCH transmitted in the previous reserved sub-frame.

The following example demonstrates how this method may be applied. Assume 8 synchronous HARQ processes. The sub-frames corresponding to HARQ processes 0 and 4 may be configured to always use the special E-DPCCH format. These HARQ processes may only transmit data from a predetermined logical channel, such as a channel including voice data. Whenever the WTRU 210 determines that bundling is needed for transmitting data from either HARQ process 0 or 4, the WTRU 210 indicates this in the corresponding E-DPCCH transmission. Then, subsequent sub-frames (e.g., in this case, for HARQ process 0, the processes normally where transmissions from HARQ processes 1 to 3 may have occurred) are utilized for bundled retransmissions of HARQ process 0, and these sub-frames may use the special E-DPCCH format. In the opposite case (no TTI bundling), the WTRU 210 transmits from HARQ processes 1 to 3 using the normal E-DPCCH format.

Discussed now are example flowcharts with the disclosure presented herein. The example flowcharts are illustrative and not limiting with respect to the disclosure presented herein. The WTRU 210 and base station 220 are configured to perform the example flowcharts discussed herein.

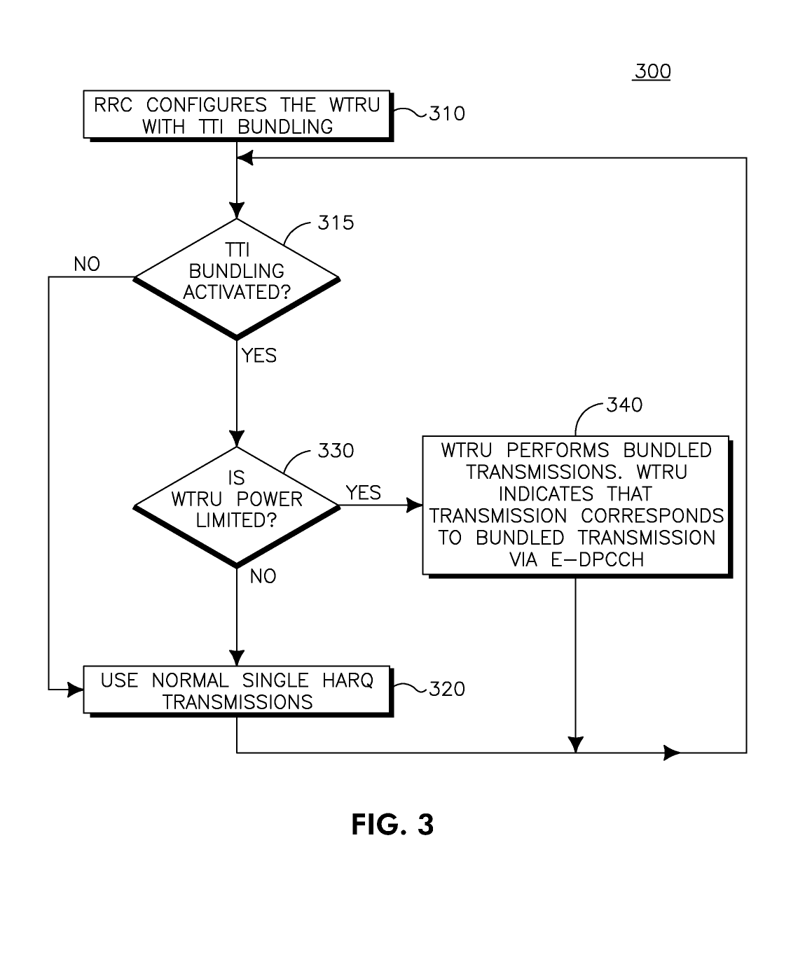

FIG. 3 illustrates an example flowchart 300 for determining if TTI bundling should be used using the criteria and signaling disclosed herein. Referring also to FIG. 2, the WTRU 210 receives a RRC TTI bundling configuration (310), wherein the RRC configures the WTRU 210 to use TTI bundling and provides any applicable parameters. If for the given TTI, the WTRU 210 has data to transmit, e.g., E-TFC selection is being performed for a given HARQ process or if the WTRU 210 is performing a HARQ retransmission, the WTRU 210 determines if TTI bundling is active (315). As described herein, TTI bundling activation/deactivation may be controlled using at least different two signaling methods. In a first example, TTI bundling activation/deactivation may be controlled via activation/deactivation messages that are received, for example, via a L1 signal such as an E-AGCH or HS-SCCH order. If an activation or deactivation message is received, TTI bundling is set to active or inactive, respectively. In another example method, the RRC TTI bundling configuration message activates TTI bundling upon reception of the RRC TTI bundling configuration message (310). Additionally, L1 signaling may further activate/deactivate TTI bundling. Alternatively, the WTRU 210 may consider TTI bundling active/inactive only after a L1 message has been received. It is understood that if an RRC TTI bundling configuration message is removing the TTI bundling configuration, TTI bundling is inactive. If the WTRU 210 determines that TTI bundling is not active, then the WTRU 210 performs normal HARQ processing (320). The WTRU 210 may also transmit a notification message to, for example base station 220, that TTI bundling is not being performed (320). This notification message may be transmitted via, for example, the E-DPCCH.

If TTI bundling is active or was already active, the WTRU 210 then determines if the WTRU 210 has become power limited using one of the criteria discussed herein (330). For example, the WTRU 210 may check the uplink power headroom, make a CPICH measurement and determination, check the NRPM, calculate remaining power margin or determine if the transmit power exceeds the maximum allowed power value (330). If the WTRU 210 determines that it is power limited (330), the WTRU 210 performs bundled transmissions (340). The WTRU 210 may also transmit a notification message to, for example base station 220, that the transmission corresponds to a bundled transmission (340). This notification message may be transmitted via, for example, the E-DPCCH. If the WTRU 210 determines that it is not power limited (340), then the WTRU 210 uses normal HARQ processing (320). The WTRU 210 may also transmit a notification message to, for example base station 220, that TTI bundling is not being performed (320). This notification message may be transmitted via, for example, the E-DPCCH.

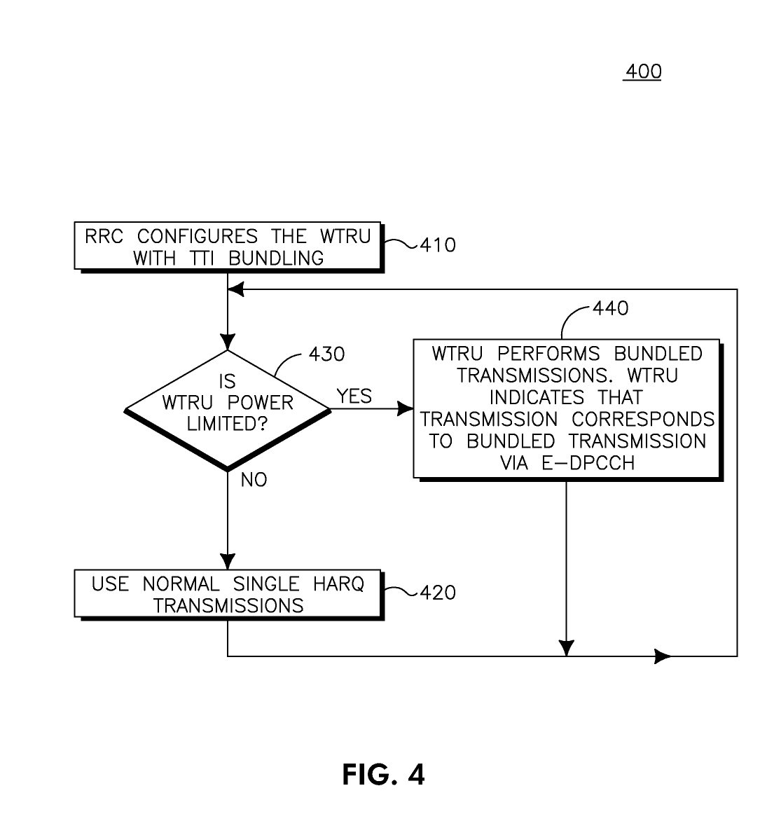

Referring now FIG. 4, flowchart 400 shows an example L3 TTI bundling method. The WTRU 210 has been configured with TTI bundling and is in an active mode based on configuration information sent via, for example, a RRC TTI bundling configuration message (410). Although not illustrated, the RRC TTI bundling configuration message may deactivate TTI bundling once TTI bundling has been activated.

Once configured by an RRC TTI bundling configuration message, the WTRU 210 then determines if the WTRU 210 has become power limited using one of the criteria discussed herein when data transmission is being performed or E-TFC selection is being performed or if the WTRU 210 is performing a HARQ retransmission (430). For example, the WTRU 210 may check the uplink power headroom, make a CPICH measurement and determination, check the NRPM, calculate remaining power margin or determine if the transmit power exceeds the maximum allowed power value (430). If the WTRU 210 determines that it is power limited (430), the WTRU 210 performs bundled transmissions (440). The WTRU 210 may also transmit a notification message to, for example base station 220, that the transmission corresponds to a bundled transmission (440). This notification message may be transmitted via, for example, the E-DPCCH. If the WTRU 210 determines that it is not power limited (440), then the WTRU 210 uses normal HARQ processing (420). The WTRU 210 may also transmit a notification message to, for example base station 220, that TTI bundling is not being performed. This notification message may be transmitted via, for example, the E-DPCCH (420).

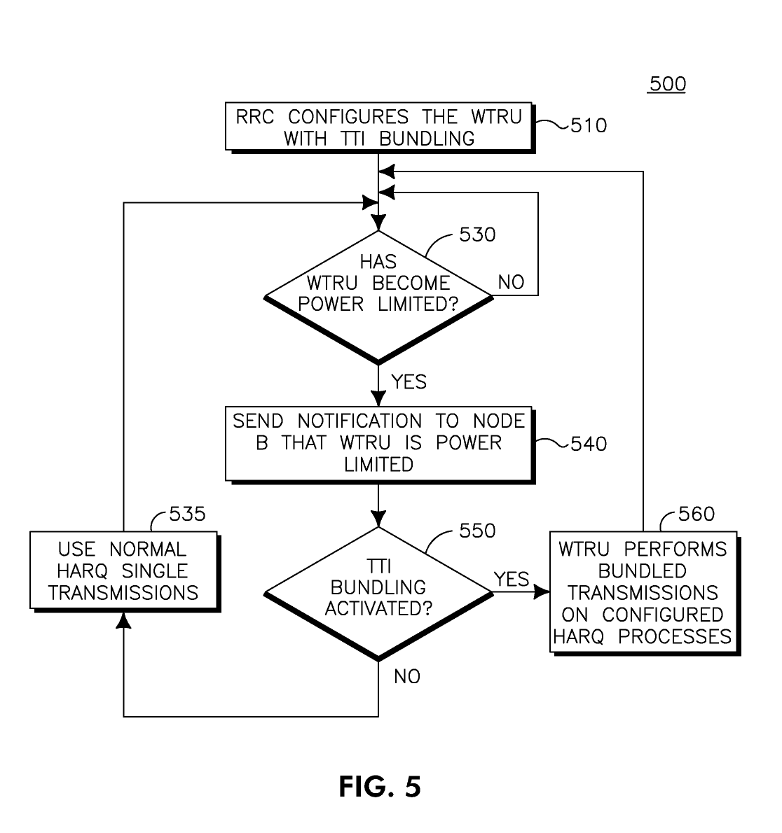

Referring now FIG. 5, flowchart 500 shows another example L3 TTI bundling method. The WTRU 210 has been configured with TTI bundling and may be in an active mode based on configuration information sent via, for example, a RRC TTI bundling configuration message (510). Although not illustrated, the RRC TTI bundling configuration message may deactivate TTI bundling once TTI bundling has been activated.

Once configured by an RRC TTI bundling configuration message, the WTRU 210 then determines if the WTRU 210 has become power limited using one of the criteria discussed herein (530). For example, the WTRU 210 may check the uplink power headroom, make a CPICH measurement and determination, check the NRPM, calculate remaining power margin or determine if the transmit power exceeds the maximum allowed power value (530). The power limitation check is continuous for so long as the WTRU 210 is in TTI bundling configuration mode (530). The WTRU 210 may also send a notification that the WTRU 210 has become power limited or is no longer power limited. Alternatively, this notification message may be sent after the WTRU 210 was power limited and is now no longer power limited.

If the WTRU 210 determines that it has become or is power limited (530), the WTRU 210 transmits a notification message to, for example base station 220 that the WTRU 210 is power limited (540). For example, the notification may be sent by triggering the transmission of a Scheduling Information (SI). The WTRU 210, when data transmission is being performed or E-TFC selection is being performed, then checks if TTI bundling is active (550). As described herein, the WTRU 210 sets TTI bundling to active when it receives a TTI bundling activation message and it sets it to inactive when a TTI bundling deactivation message is received. If a TTI bundling activation message is received via for example an L1 signaling element and TTI bundling is set to active, then the WTRU 210 performs bundled transmissions (560). The WTRU 210 may also transmit a notification message to, for example base station 220, that the transmission corresponds to a bundled transmission (560). If the TTI bundling activation message is not received or if a TTI bundling deactivation message is received and TTI bundling is inactive (550), then the WTRU 210 performs normal single HARQ transmissions (535) and continues to check power limitations (530). The WTRU 210 may also transmit a notification message to, for example base station 220, that TTI bundling is not being performed (535). This notification message may be transmitted via, for example, the E-DPCCH.

Although features and elements are described herein in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for implementing transmission time interval (TTI) bundling in a wireless transmit/receive unit (WTRU), the method comprising:
receiving a TTI bundling configuration message via at least one of a layer one (L1), a layer two (L2) or a layer three (L3) signaling element;
determining that TTI bundling is to be performed based on the TTI bundling configuration message and on a condition that at least one criteria is met; and
transmitting a notification on a condition that TTI bundling is being performed.

2. The method of claim 1, wherein the TTI bundling configuration message is one of an activation message, deactivation message or configuration information message.

3. The method of claim 1, wherein the TTI bundling configuration message is a radio resource controller (RRC) message that configures the WTRU to use TTI bundling and provides configuration information.

4. The method of claim 3, further comprising receiving an additional configuration message used to activate or deactivate TTI bundling.

5. The method of claim 1, wherein the L1 signaling element is an enhanced-absolute grant channel (E-AGCH).

6. The method of claim 1, wherein the L1 signaling element is a high speed-shared control channel (HS-SCCH) order.

7. The method of claim 1, wherein determining the at least one criteria checks that an uplink power headroom measurement is below a threshold to trigger TTI bundling.

8. The method of claim 1, wherein determining the at least one criteria checks that a common pilot channel (CPICH) measurement is below a threshold to trigger TTI bundling.

9. The method of claim 1, wherein determining the at least one criteria checks that a normalized remaining power margin (NRPM) is below a threshold to trigger TTI bundling.

10. The method of claim 1, wherein determining the at least one criteria checks that a remaining power margin is below a required power level to transmit any of a configured set of enhanced-transport format combination indication (E-TFCI) to trigger TTI bundling.

11. The method of claim 1, wherein determining the at least one criteria checks that transmit power exceeds a maximum allowed power value to trigger TTI bundling.

12. The method of claim 1, wherein determining the at least one criteria checks that one of a highest logical channel or MAC-d flow belongs to a list of allowed logical channels for TTI bundling to trigger TTI bundling.

13. The method of claim 1, further comprising reserving at least one hybrid-automatic repeat request (HARQ) process for TTI bundling.

14. The method of claim 1, wherein the notification is transmitted via a reserved value in a scheduling information (SI).

15. The method of claim 1, wherein the notification is signaled via an enhanced-transport format combination indication (E-TFCI) field in an enhanced-downlink physical control channel (E-DPCCH) via at least one of reducing the E-TFCI field and using a subset of the E-TFCI field and/or using at least one remaining bit and/or using at least one additional bit to indicate the use of TTI bundling.

16. The method of claim 1, wherein the notification is signaled via a reinterpretation of a retransmission sequence number (RSN) field in an enhanced-downlink physical control channel (E-DPCCH).

17. The method of claim 1, further comprising performing the determination on a per TTI basis.

18. The method of claim 1, wherein the TTI bundling configuration message is a radio resource controller (RRC) message that configures and activates TTI bundling at the WTRU.

19. The method of claim 1, further comprising:
receiving configuration information in the TTI bundling configuration message; and
using the configuration information on a condition that a further TTI bundling configuration message contains one of an activation message or a deactivation message.

20. A wireless transmit/receive unit (WTRU) configured to support transmission time interval (TTI) bundling, the WTRU comprising:
a receiver;
a transmitter; and
a processor in communication with the receiver and transmitter, the processor configured to receive a TTI bundling configuration message via at least one of a layer one (L1), a layer two (L2) or a layer three (L3) signaling element; configured to determine that TTI bundling is to be performed based on the TTI bundling configuration message and on a condition that at least one criteria is met; and configured to transmit a notification on a condition that TTI bundling is being performed.
